(19) United States
(12) Patent Application Publication
(10) Pub. No.: US 2014/0156485 A1
(43) Pub. Date: Jun. 5, 2014

(54) Method and Systems for Advanced Spread Price Calculation

(71) Applicant: TRADING TECHNOLOGIES INTERNATIONAL, INC., Chicago, IL (US)

(72) Inventors: Jason Shaffer, Chicago, IL (US); Sagy Pundak Mintz, Lincolnshire, IL (US)

(73) Assignee: Trading Technologies International, Inc., Chicago, IL (US)

(21) Appl. No.: 13/691,225

(22) Filed: Nov. 30, 2012

(51) Int. Cl. G06Q 40/04

(52) U.S. Cl. CPC G06Q 40/04
USPC 705/37

(57) ABSTRACT

Methods and systems for advanced spread price calculation are disclosed. An example method to calculate a spread price includes receiving a trading spread including a plurality of legs, wherein each leg of the plurality of legs is associated with a tradeable object. The example method includes facilitating a definition of a mathematic equation that describes a relationship between each of the plurality of legs based on at least two parameters relating the plurality of legs to the spread price. The example method includes calculating the spread price based on the defined mathematic equation.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

Trading strategies enable traders to set rules for trading decisions. One example trading strategy is known as spread trading. Spread trades are executed to yield an overall net position whose value depends on the difference between the prices of the tradeable objects of the trading strategy.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy which may be employed with certain disclosed embodiments.

FIG. 5 illustrates a flow diagram representative of example machine readable instructions that may be executed to implement advanced spread price calculation.

FIG. 6 illustrates a flow diagram representative of example machine readable instructions that may be executed to implement disclosed embodiments.

FIG. 7 illustrates a flow diagram representative of example machine readable instructions that may be executed to implement disclosed embodiments.

FIG. 8 illustrates a flow diagram representative of example machine readable instructions that may be executed to implement disclosed embodiments.

FIG. 9 illustrates a flow diagram representative of example machine readable instructions that may be executed to implement disclosed embodiments.

FIG. 10 illustrates a block diagram of an example spread price calculation system that can implement the example machine readable instructions of FIGS. 5-9.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to electronic trading environments and, more particularly, to methods and systems for advanced spread price calculation.

A trading spread defines a relationship between two or more tradeable objects (e.g., instruments, options, future contracts, etc.) to be traded at the same time. Each tradeable object included in the trading spread may be referred to as a leg or outright market of the trading spread. Prior trading systems define the legs of the trading spread and then calculate a spread price by adding and subtracting the price of each defined leg. Whether the leg price is added or subtracted is determined based on characteristics associated with the leg when defining the leg. To meaningfully calculate the spread price, each leg defined in the trading spread needs to be in the same currency. An example leg characteristic is a spread ratio that indicates the quantity of each leg in the trading spread in relation to the other legs. A positive spread ratio indicates that the leg is to be bought (e.g., a positive multiplier) and a negative spread ratio indicates that leg is to be sold (e.g., a negative multiplier) when buying the trading spread. Thus, buying a trading spread involves buying and selling each leg defined in the trading spread. Additionally, each leg corresponds to a tradeable object and has the same currency as the other defined legs.

Embodiments disclosed herein recognize that trades may include buying and selling tradeable objects across foreign markets and, thus, a trading spread may include tradeable objects that trade with different currencies. Embodiments disclosed herein also recognize that a leg may be used in a trading spread to only modify the spread price and, thus, may not need to be bought or sold when the trading spread is traded.

Unlike prior trading systems, embodiments described herein implement calculating a spread price using a mathematic equation that is based on a trading spread. Specifically, the mathematic equation is generated using the legs defined in the trading spread and parameters relating the legs. For example, a leg may be a tradeable object, a constant, a currency exchange rate and/or any other variable which may change the value while calculating the spread price. Parameters relating the legs may indicate addition, subtraction, multiplication, division and/or any other mathematical operation relating two or more legs of the trading spread. According to embodiments described herein, a trading spread may indicate which legs of the trading spread to include in a trade order. In some such examples, the trading spread may also indicate any legs of the trading spread to not include in the trade order.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide a method to calculate a spread price including receiving a trading spread including a plurality of legs, wherein each leg of the plurality of legs is associated with a tradeable object. The example method also includes facilitating a definition of a mathematic equation that describes a relationship between each of the plurality of legs based on at least two parameters relating the plurality of legs to the spread price. The example method also includes calculating the spread price based on the defined mathematic equation.

Certain embodiments provide a method to define a trading spread having a plurality of tradeable objects including facilitating a definition of a first leg used in the trading spread, wherein the first leg is a tradeable object. The example method also includes facilitating a definition of a second leg used in the trading spread, wherein the second leg is a tradeable object. The example method also includes facilitating a definition of the trading spread including the first leg and the second leg, wherein the trading spread is based on a mathematic equation that is to describe a relationship between the first leg and the second leg, and the relationship is based on at least a parameter related to at least the first leg or the second leg.

Certain embodiments provide a tangible computer readable storage medium including computer program code to be executed by a processor, the computer program code, when executed, to implement a method to calculate a spread price including receiving a trading spread including a plurality of legs, wherein each leg of the plurality of legs is associated with a tradeable object. The example tangible computer readable storage medium also includes computer program code to facilitate a definition of a mathematic equation that describes a relationship between each of the plurality of legs based on at least two parameters relating the plurality of legs to the spread price. The example tangible computer readable storage medium also includes computer program code to calculate a leg value corresponding to each of the plurality of legs. The example tangible computer readable storage medium also includes computer program code to calculate the spread price based on the mathematic equation.

### II. Example Electronic Trading System

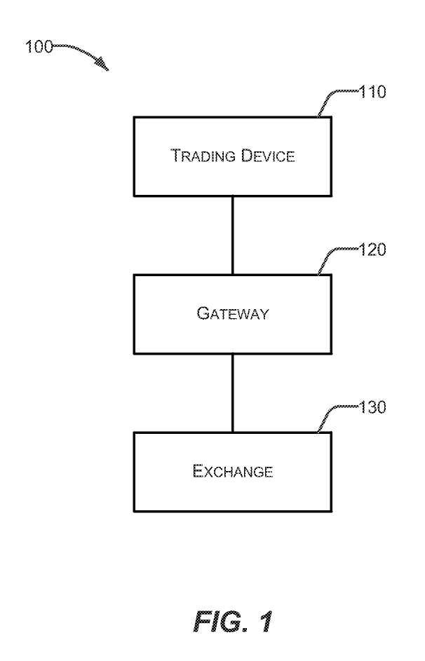

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

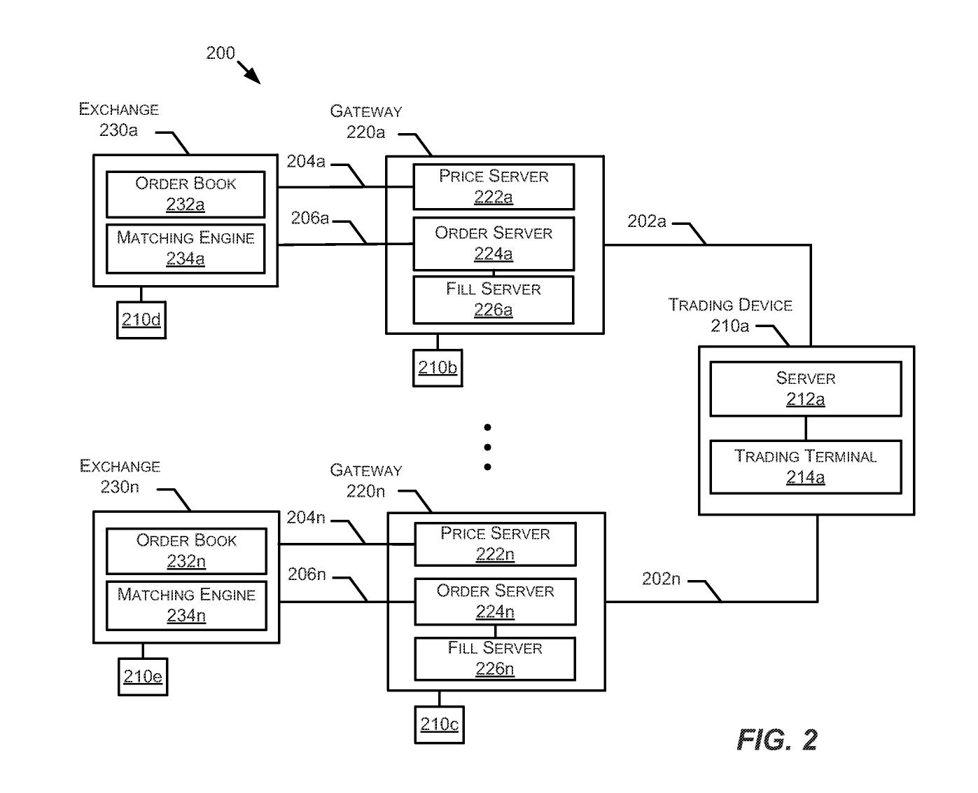

FIG. 2 illustrates a block diagram of another example electronic trading system 200 in which certain embodiments may be employed. In this example, a trading device 210a is in communication with an exchange 230a through a gateway 220a. The following discussion mainly focuses on the trading device 210a, gateway 220a, and the exchange 230a. However, the trading device 210a may also be connected to and communicate with any number of gateways 220n connected to exchanges 230n. The communication between the trading device 110a and other exchanges 230n may be the same, similar, or different than the communication between the trading device 210a and exchange 230a. Generally, each exchange has its own preferred techniques and/or formats for communicating with a trading device, a gateway, the user, or another exchange.

The trading device 210a, which may be similar to the trading device 110 in FIG. 1, may include a server 212a in communication with a trading terminal 214a. The server 212a may be located geographically closer to the gateway 120 than the trading terminal 214a. As a result, the server 212a latency benefits that are not afforded to the trading terminal 214a. In operation, the trading terminal 214a may provide a trading screen to a user and communicate commands to the server 212a for further processing. For example, a trading algorithm may be deployed to the server 212a for execution based on market data. The server 212a may execute the trading algorithm without further input from the user. In another example, the server 212a may include a trading application providing automated trading tools and communicate back to the trading terminal 214a. The trading device 210a may include, additional, different, or fewer components.

The trading device 210a may communicate with the gateway 220a using one or more communication networks. As used herein, a communication network is any network, including the Internet, which facilitates or enables communication between, for example, the trading device 210a, the gateway 220a and the exchange 220a. For example, as shown in FIG. 2, the trading device 210a may communicate with the gateway 220a across a multicast communication network 202a. The data on the network 202a may be logically separated by subject (for example, prices, orders, or fills). As a result, the server 212a and trading terminal 214a can subscribe to and receive data (for example, data relating to prices, orders, or fills) depending on their individual needs.

The gateway 220a, which may be similar to the gateway 120 of FIG. 1, may include a price server 222a, order server 224a, and fill server 226a. The gateway 220a may include additional, different, or fewer components. The price server 222a may process price data. Price data includes data related to a market for one or more tradeable objects. The order server 224a may process order data. Order data is data related to a user's trade orders. For example, order data may include order messages, confirmation messages, or other types of messages. The fill server collects and provides fill data. Fill data includes data relating to one or more fills of trade orders. For example, the fill server 226a may provide a record of trade orders, which have been routed through the order server 224a, that have and have not been filled. The servers 222a, 224a, 226a may run on the same machine or separate machines.

The gateway 220a may communicate with the exchange 230a using one or more communication networks. For example, as shown in FIG. 2, there may be two communication networks connecting the gateway 220a and the exchange 230a. The network 204a may be used to communicate market data to the price server 222a. In some instances, the exchange 230a may include this data in a data feed that is published to subscribing devices. The network 206a may be used to communicate order data.

The exchange 230a, which may be similar to the exchange 130 of FIG. 1, may include an order book 232a and a matching engine 234a. The exchange 230a may include additional, different, or fewer components. The order book 232a is a database that includes data relating to unmatched quantity of trade orders. For example, an order book may include data relating to a market for a tradeable object, such as the inside market, market depth at various price levels, the last traded price, and the last traded quantity. The matching engine 234a may match contra-side bids and offers. For example, the matching engine 234a may execute one or more matching algorithms that match contra-side bids and offers. A sell order is contra-side to a buy order with the same price. Similarly, a buy order is contra-side to a sell order with the same price.

In operation, the exchange 230a may provide price data from the order book 232a to the price server 222a and order data and/or fill data from the matching engine 234a to the order server 224a. Servers 222a, 224a, 226a may translate and communicate this data back to the trading device 210a. The trading device 210a, for example, using a trading application, may process this data. For example, the data may be displayed to a user. In another example, the data may be utilized in a trading algorithm to determine whether a trade order should be submitted to the exchange 230a. The trading device 210a may prepare and send an order message to the exchange 230a.

In certain embodiments, the gateway 220a is part of the trading device 210a. For example, the components of the gateway 220a may be part of the same computing platform as the trading device 210a. As another example, the functionality of the gateway 220a may be performed by components of the trading device 210a. In certain embodiments, the gateway 220a is not present. Such an arrangement may occur when the trading device 210a does not need to utilize the gateway 220a to communicate with the exchange 230a, for example. For example, if the trading device 210a has been adapted to communicate directly with the exchange 230a.

Additional trading devices 210b-210e, which are similar to trading device 210a, may be connected to one or more of the gateways 220a-220n and exchanges 230a-230n. Furthermore, additional gateways, similar to the gateway 220a, may be in communication with multiple exchanges, similar to the exchange 230a. Each gateway may be in communication with one or more different exchanges, for example. Such an arrangement may, for example, allow one or more trading devices 210a to trade at more than one exchange (and/or provide redundant connections to multiple exchanges).

### IV. Example Computing Device

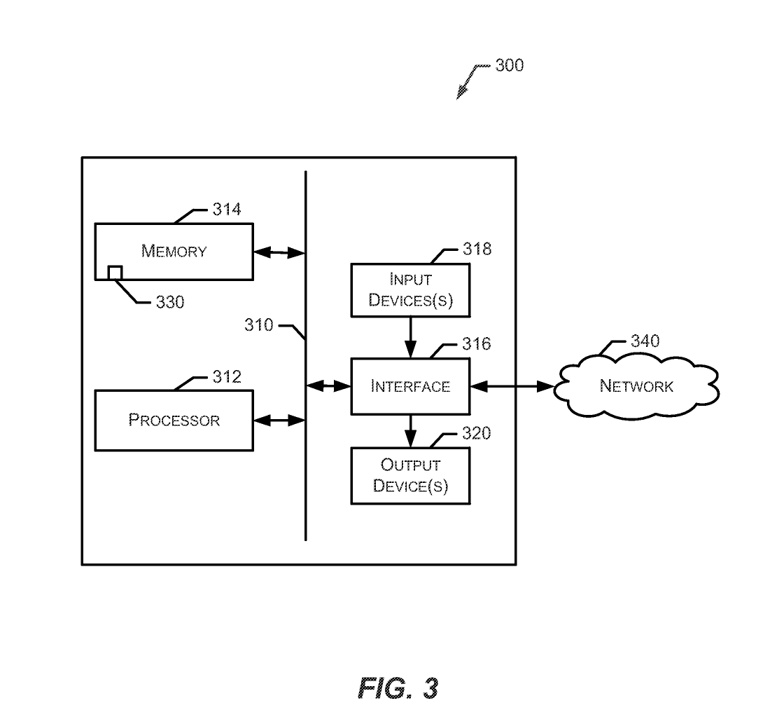

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable object in the trading strategy, for example.

An automated trading tool may, for example, be utilized to trade according to a trading strategy. In certain embodiments, the automated trading tool may be AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

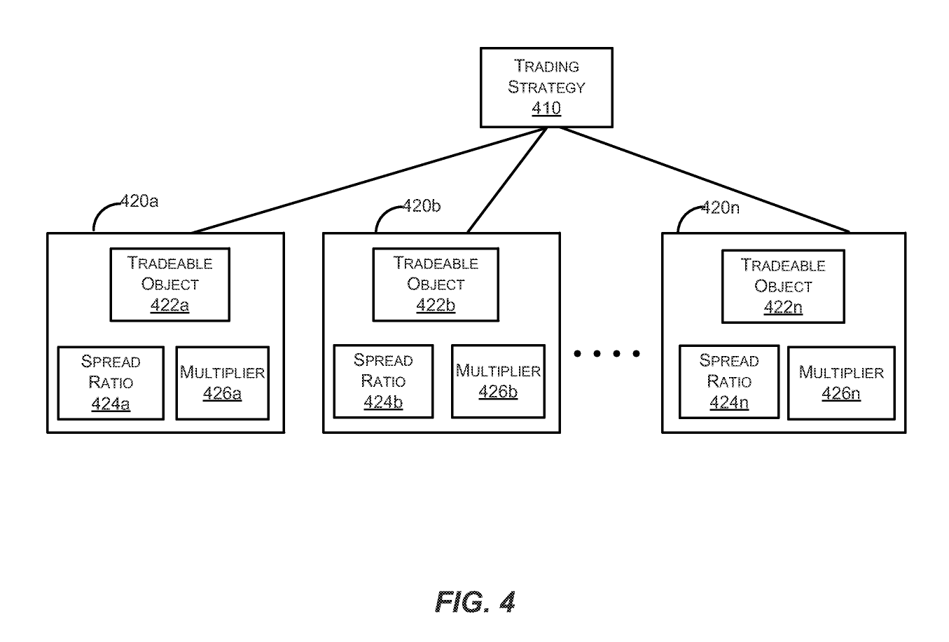

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420 comprising the tradeable objects 422 multiplied by corresponding multipliers 426. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Advanced Spread Price Calculation

As the global trading market becomes more accessible to traders, buying and/or selling tradeable objects in foreign markets also becomes more accessible. For example, a trader located in Chicago is able to buy and sell future contracts for commodities listed on the Tokyo Commodity Exchange. Additionally, a trader may trade more than one tradeable object in these foreign markets according to a trading strategy. In some instances, buying and/or selling tradeable objects across foreign markets is beneficial to a trader. For example, rather than buying and selling tradeable objects listed only on the New York Mercantile Exchange (NYME) or listed only on the Tokyo Commodity Exchange (TOCOM), a trading strategy may buy futures contracts listed on the NYME and sell futures contracts for commodities listed on the TOCOM. Thus, when a trader is buying and/or selling multiple tradeable objects across multiple foreign markets, it is beneficial for the trader to have greater control over defining the trading spread or calculating the spread price.

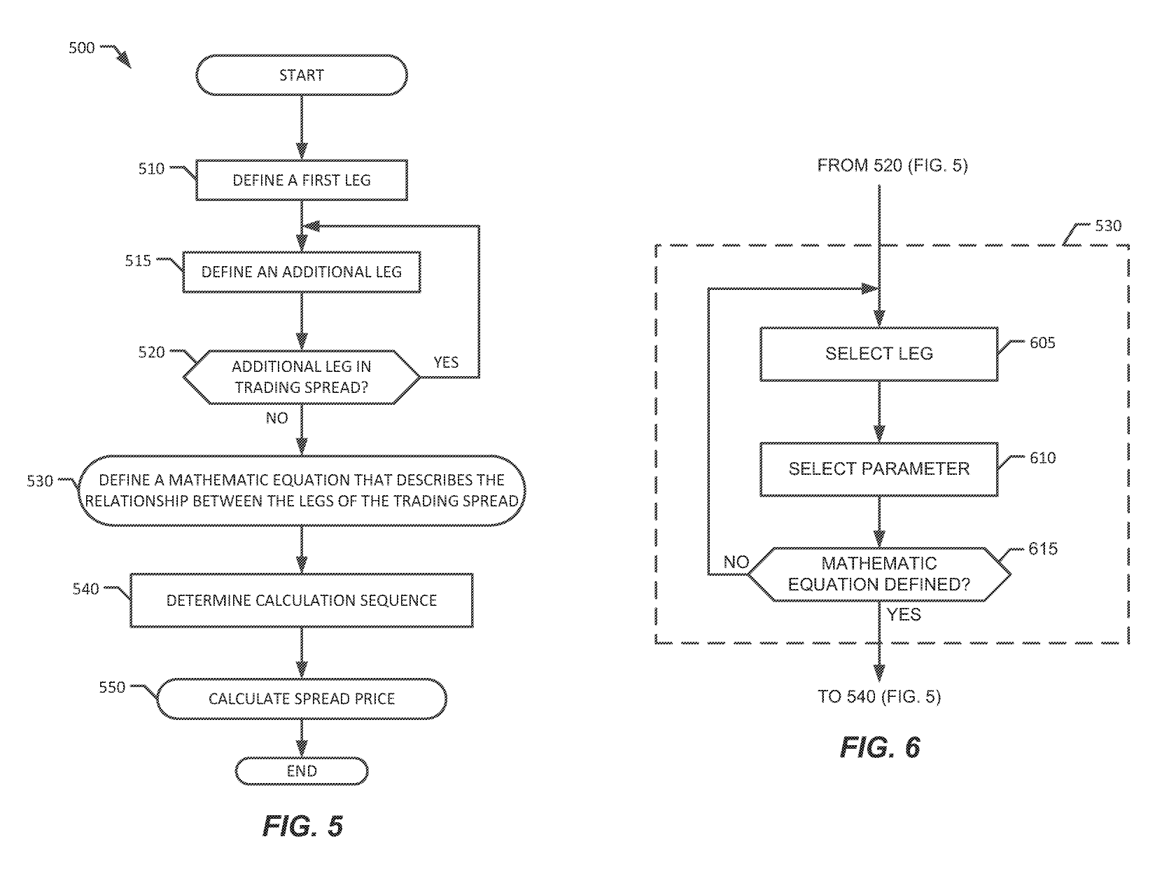

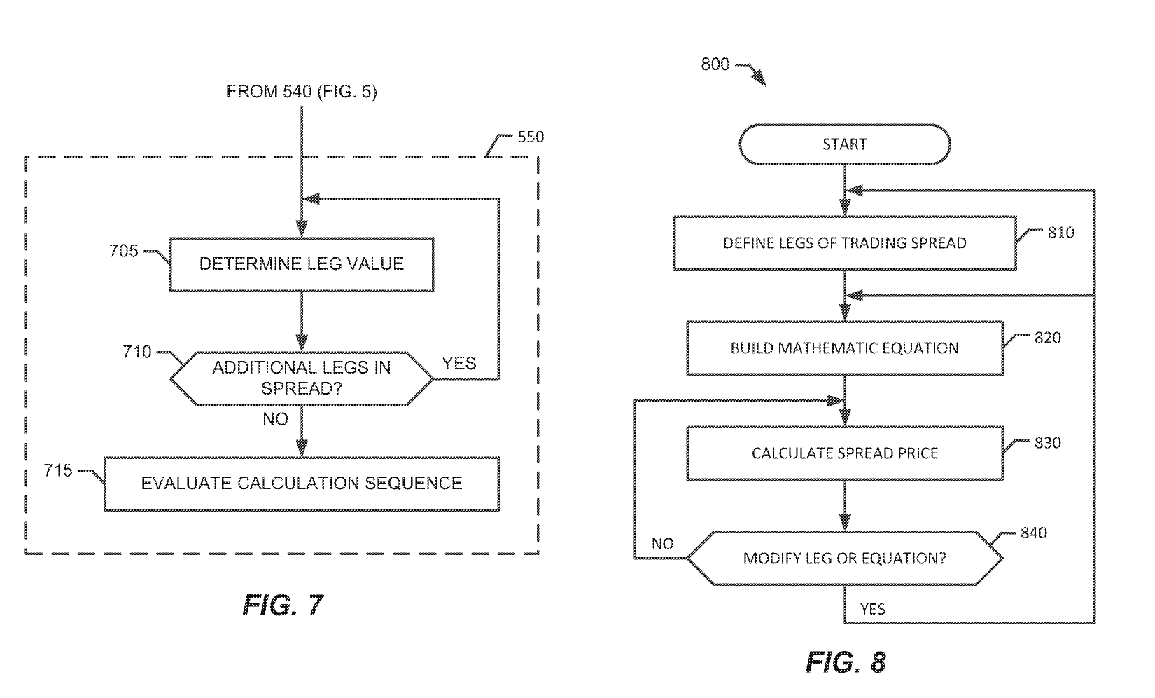

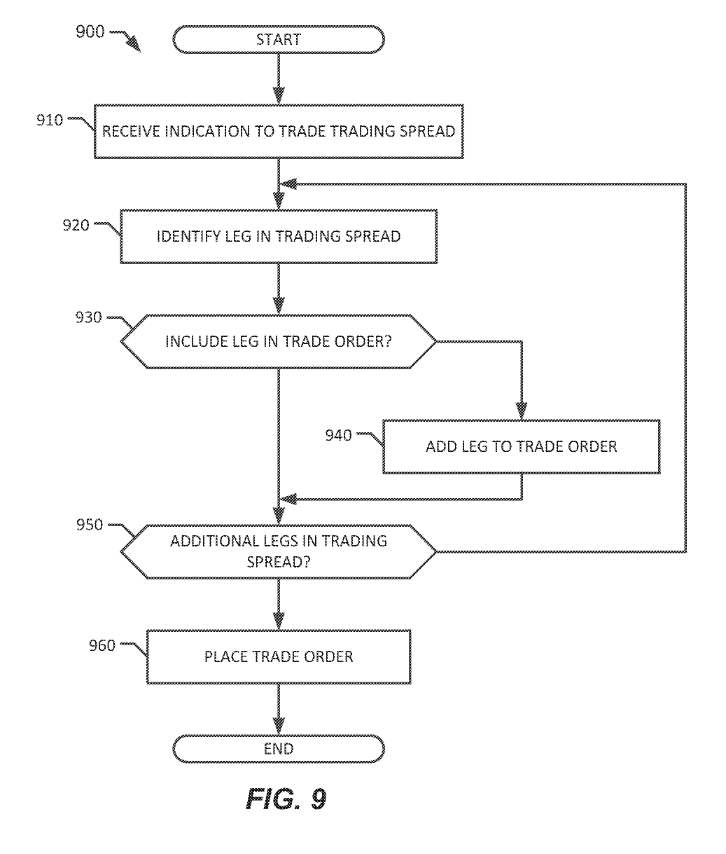

FIGS. 5-9 are flow diagrams representative of example operations that can be executed to implement the teachings of this disclosure. The example operations of FIGS. 5-9 can be implemented by, for example, the example trading device 110 of FIG. 1 and/or the example trading device 210 of FIG. 2. While the example trading device 110 of FIG. 1 is described as executing the example operations of FIGS. 5-9 below, any suitable device can execute the example operations of FIGS. 5-9. The example operations of FIGS. 5-8 implement calculating a spread price of a trading spread based on a mathematic equation that describes a relationship between any legs defined in the trading spread. The example operations of FIG. 9 include determining a trade order based on the legs defined in the trading spread.

To calculate a spread price, a user and/or trading device defines a trading spread using legs. The example process 500 of FIG. 5 begins when a trader defines a first leg of a trading spread (block 510). In the illustrated example, the first leg is defined by a value. The first leg may be defined by a dynamic value (e.g., a variable) or a static value (e.g., a constant). For example, a variable such as a tradeable object (e.g., an instrument, an option, a futures contract, etc.) may be selected as part of the definition of the first leg. In some such examples, the value of the first leg changes according to the market price of the tradeable object. In some examples, the value of the first leg may be defined by a variable other than a tradeable object. For example, the value may be an exchange rate. A currency exchange rate is useful when trading across multiple exchange markets. For example, a trader wishes to buy 100,000 barrels of US crude oil, which is traded in dollars per barrel, and sell 150,000 barrels of Japanese crude oil, which is traded in yen per barrel. In other words, for every barrel of US crude oil bought, 1.5 barrels of Japanese crude oil is sold. Calculating a spread price with just these two legs results in a nonsensical price. Thus, defining a leg as a currency exchange rate between yen and dollars enables calculating a spread price in dollars or yen, for example. In some examples, the value of the first leg may be a constant. For example, Japanese crude oil may be sold in kiloliters. Thus, it may be beneficial to define a leg as the conversion between barrels and kiloliters.

In some examples, the value of the leg may be modified by one or more factors associated with the leg. For example, the first leg may be weighted by including a multiplier. In other examples, a spread ratio may describe the quantity of the first leg traded in relation to the other legs in the trading spread. Other factor(s) to adjust the value of the first leg are also possible. When the first leg is defined, a second leg is defined in a similar manner as the first leg (block 515). For example, the second leg may include a constant and/or a variable (e.g., a tradeable object, an exchange rate, etc.). When the trading spread includes an additional leg to define, control returns to block 515 to define the additional leg (block 520). For example, in the US crude oil and Japanese crude oil example, the first leg may be defined as US crude oil, the second leg may be defined as Japanese crude oil, and a third leg may be defined as a yen-to-dollars exchange rate. In some examples, one or more factors of a leg may be modified after the leg is defined. In some such examples, the leg to modify is identified, and the steps to define the leg are provided again. For example, the trader may decide to modify the third leg to a dollars-to-yen exchange rate, rather than the yen-to-dollars exchange rate.

TABLE 1

| Leg | Variable | Multiplier | Market Price |
|---|---|---|---|
| Leg1 | CME Crude Oil Nov12 Futures | 1/100 | 8950 |
| Leg2 | TOCOM CRUD 2013/03 | 1/8.3864 | 52300 |
| Leg3 | CME JPY/USD Dec12 | 1/1000000 | 12716 |

Table 1 illustrates there example legs after each leg is defined. Each leg is defined by a variable (e.g., CME Crude Oil Nov12 Futures, etc.) and a factor such as a multiplier (e.g., 1/100, etc.).

When all the legs of the trading spread are defined, the relationship between the legs of the trading spread can be established via a mathematic equation (block 530). The mathematic equation defines how the spread price is calculated. In other words, the mathematic equation describes how each leg defined in the trading spread relates to or modifies the spread price. FIG. 6 is a flow diagram representative of example operations that can be executed to implement block 530 of FIG. 5, which defines a mathematic equation based on the trading spread. In the example of FIG. 6, the mathematic equation is defined by describing a relationship between each of the defined legs of the trading spread as a function of parameters such as, for example, mathematical operators, variables and/or constants. That is, while a factor(s) modifies the definition of a leg in the trading spread, a parameter(s) relates the legs of the trading spread to the spread price. The example process of FIG. 6 to define the mathematic equation begins when one of the defined legs is selected (block 605). In the illustrated crude oil example, the first leg (e.g., the US crude oil leg) is selected. A parameter relating the first leg to the spread price is selected (block 610). The parameter may operate on a single leg (e.g., negate the value of a leg) and/or may operate on two or more legs (e.g., sum the values of three legs). Example mathematical operators or parameters include addition, subtraction, multiplication, division, exponentiation, delimiters (e.g., parentheses (“( )”), brackets (“[ ]”), braces or curly brackets (“{ }”), etc.), and/or any other algebraic operation relating a leg of the trading spread to the spread price. Additionally or alternatively, example parameters may include constants or variables. For example, rather than modifying the second leg with a factor (e.g., weighting the second leg with a multiplier) so that 1.5 times as many units of the second leg are traded for each unit of the first leg traded, a parameter selected in the mathematic equation may indicate to multiply the value of the second leg by 1.5. After selecting the parameter, the process determines whether defining the mathematic equation is complete (block 620). For example, the process may check whether all the defined legs of the trading spread are related by the mathematic equation. Additionally and/or alternatively, manual input may indicate the mathematic equation is defined. When defining the mathematic equation is not complete (block 620), control returns to block 605 to select another leg to describe in the mathematic equation.

In the illustrated crude oil example, an example mathematic equation to calculate the spread price in dollars is defined. In this example, the spread price when buying 100,000 barrels of US crude oil (e.g., the first leg) and selling 150,000 barrels of Japanese crude oil (e.g., the second leg) at the same time is calculated. As described above, taking the sum of the first leg and the second leg results in a nonsensical price. Therefore, to calculate a meaningful spread price, a mathematical relationship between the first leg and the second leg is established. In some examples, a multiplier corresponding to the exchange rate between dollars and yen may be associated with the first leg or the second leg. However, the multiplier association results in static conversion. For example, the exchange rate is fixed and does not change dynamically to reflect the state of the exchange market, resulting in an estimate of the spread price rather than the spread price experienced when trading the trading spread. Defining a third leg as an exchange rate variable, and then establishing a mathematical relationship between the third leg and the first leg or the second leg can be used to establish a mathematical relationship between the first leg and the second leg. For instance, a third leg to convert yen-to-dollars is defined, for example, at block 515 of FIG. 5. Selecting the second leg (block 605), selecting a multiplication parameter (block 610), and then selecting the third leg (block 605) results in converting the units of the Japanese crude oil to dollars per barrel. Equation 1 is an example mathematic equation to calculate the spread price:

Spread Price=Leg1−(Leg2*Leg3) (EQN 1)

Thus, a mathematic equation representative of buying the first leg and selling the product of the second leg and the third leg calculating the spread price in dollars may be defined. The example of FIG. 6 then ends and control returns to process 500 of FIG. 5.

Returning to the example process 500 of FIG. 5, a calculation sequence is determined based on the selected mathematical operators and/or parameters (block 540). For example, the unit of the Japanese crude oil is to be converted to dollars per barrel before subtracting the value of the Japanese crude oil leg from the value of the US crude oil leg. In another example, the spread price may be the quotient of the difference of two legs (e.g., leg A−leg B) and the sum of the two legs (e.g., leg A+leg B). As a result, the difference of the two legs and the sum of the two legs are to be calculated prior to calculating the quotient.

When the calculation sequence of the mathematic equation is determined (block 540), the spread price is calculated (block 550). The spread price of the trading spread is calculated based on the mathematic equation describing the relationship between the legs of the trading spread. Additionally, the spread price is calculated in an order (or sequence) corresponding to the calculation sequence determined in block 540. FIG. 7 is a flowchart representative of example operations that can be executed to implement block 550 of FIG. 5, which calculates a spread price. In the example of FIG. 7, the spread price is calculated by determining the value of each leg in the trading spread and then evaluating the mathematic equation based on the calculation sequence. The example process of FIG. 7 begins by determining a leg value (block 705). For example, if a leg is defined by a variable such as a tradeable object, the market price of the tradeable object is retrieved. In some such examples, if a leg factor(s) is associated with the leg, such as a leg multiplier, the value of the leg is adjusted accordingly. In other examples, if the leg is defined by a variable, such as an exchange rate, the exchange rate may be retrieved from an exchange market. In some examples, the value of the leg is recorded in a local memory or register, and retrieved, for example, when evaluating the mathematic equation. If there are additional legs in the spread (block 710), control returns to block 705 to determine the value(s) of any additional leg(s). Equation 2 illustrates an example of determining the leg value of each leg from Table 1 using Equation 1:

Spread Price=(8950)*( 1/100)−[(52300)*( 1/8.3864)*(12716)*( 1/1000000)] (EQN 2)

If there are no additional legs in the trading spread (block 710), the spread price is calculated by evaluating the mathematic equation in the calculation sequence determined at block 540 of FIG. 5 (block 715). In some examples, the value of each leg is determined at the same time. That is, rather than sequentially determining the value of each leg, the values are determined at substantially the same time.

In the illustrated crude oil example, the value of the first leg (e.g., the US crude oil leg) is calculated by retrieving the market price of a barrel of US crude oil from, for example, the New York Mercantile Exchange (e.g., 8950); the value of the second leg (e.g., the Japanese crude oil leg) is calculated by retrieving the market price of a barrel of Japanese crude oil from, for example, the Tokyo Commodity Exchange (e.g., 52300); and, the value of the third leg (e.g., the yen-to-dollar currency exchange rate leg) is calculated by retrieving the exchange rate from, for example, the Chicago Mercantile Exchange Foreign Exchange Market (e.g., 12716). If any of the legs are associated with one or more leg factors, the value of the respective leg is adjusted accordingly. For example, the spread ratio associated with the first leg and the second leg may indicate that for each barrel of US crude oil bought, 1.5 barrels of Japanese crude oil will be sold. In the illustrated example, the first leg is associated with a first multiplier (e.g., 1/100), the second leg is associated with a second multiplier (e.g., 1/8.3864), and the third leg is associated with a third multiplier (e.g., 1/1000000). Thus, the value of each leg is calculated by multiplying the market price by the associated multiplier. For example, the value of the first leg is 89.50 (e.g., 8950* 1/100). The values of the second and third legs are found using the same or similar calculations. When the value of all three legs is known, the calculation sequence corresponding to the mathematic equation is evaluated (block 715). Thus, in the illustrated example, the product of the value of the second leg (e.g., the Japanese crude oil leg) and the value of the third leg (e.g., the yen-to-dollar currency exchange rate leg) is calculated first (e.g., 79.30). This product is then subtracted from the value of the first leg (e.g., the US crude oil leg) (e.g., 89.50) to calculate the spread price of 10.20. The example process of FIG. 7 and the example process 500 of FIG. 5 then end.

FIG. 8 is a flowchart representative of example operations that can be executed to implement another example method for advanced spread price calculation. The example process 800 of FIG. 8 begins when a trader defines legs to use in a trading spread (block 810). For example, a trader may identify whether the leg includes a static value (e.g., a constant) or a dynamic value (e.g., a variable such as a tradeable object, an exchange rate, etc.). The trader may also associate leg factor(s) (e.g., a multiplier, a spread ratio, etc.) with the leg. When the legs of the trading spread are defined, the trader builds (or defines) a mathematic equation that describes the relationship between the legs of the trading spread (block 820). For example, a trader may use a graphical user interface to arrange the legs into a sequence. Additionally, mathematical operators and/or parameters may also be provided to the trader to arrange. For example, the trader may arrange a sequence of blocks indicative of calculating the difference of two legs divided by a third leg. In other examples, the trader may build (or define) the mathematical equation by manually inputting the mathematic equation. For example, the trader may be prompted via a display to input a mathematic equation that describes the relationship between the defined legs of the trading spread. In some examples, the trader may also determine a calculation sequence for the mathematic equation. In some other examples, the calculation sequence may be generated based on the parameters arranged in the mathematic equation.

Using the mathematic equation, the spread price of the trading spread is calculated (block 830). For example, the value of each leg of the trading spread is determined. In some examples, the value is determined by retrieving a market price for a tradeable object. In some examples, the value is determined by retrieving the value of an exchange rate. In some examples, the value of the leg is a constant value. After the value of each leg is determined, the spread price is calculated by evaluating the mathematic equation in the calculation sequence. For example, a sum of three legs may be calculated first and then the sum may be divided by a fourth leg. In some examples, the calculated spread price may be displayed to the trader.

In some examples, the trader may decide to modify a leg in the trading spread or the mathematic equation (block 840). Depending on the decision, control may return to either block 810 to modify a leg or to block 820 to modify the mathematic equation. Alternatively, if the trader decides not to make a modification (block 840), control returns to block 830 to recalculate the spread price. Thus, the calculated spread price is updated to reflect the current state of the market. The example process 800 then ends.

In some examples, the trader may decide to trade the trading spread. For example, the trader may determine buying the trading spread is favorable based on the calculated spread price. FIG. 9 is a flowchart representative of example operations that can be executed to implement the trading spread in a trade order. The example process 900 of FIG. 9 begins when a request to trade the trading spread is placed (block 910). For example, an automated trading tool may automatically request to trade the trading spread when a desired spread price is achieved. In some other examples, a trader may manually request to trade the trading spread. When the request to trade is received, a leg included in the trading spread is identified (block 920). Whether to include the leg is then determined (block 930). If the trading leg includes a tradeable object to include in the trade order, the leg and a corresponding quantity to trade is added to a trade order (block 940). For example, an order to buy 100,000 US crude oil barrels is added to the trade order. The examples process 900 then determines whether there are additional legs in the trading spread (block 950).

Otherwise, if the trading leg does not include a tradeable object to include in the trade order (block 930), control proceeds to block 950 to determine whether the trading spread includes an additional leg. For example, the trading leg may include a constant value or a variable value, such as the yen-to-dollar currency exchange rate illustrated in the crude oil example. In some such examples, the leg may not be added to the trade order. In some other examples, the leg having a tradeable object is added to the trade order with a leg quantity of zero. In some examples, the leg may include a tradeable object, but the leg is selected not to include in the trade order. For example, a trader may include a tradeable object in the trading spread to modify the trading spread, but not want to trade the tradeable object. Thus, the trader may select not to include the leg in the trade order. For example, whether to trade the leg may be selected while defining the leg, such as at blocks 510 or 515 of FIG. 5. In some other examples, the decision not to trade the leg may be selected before a trade order can be made. For example, all of the legs may default to exclusion in a trade order and the trader selects which legs to include before the trading spread can be traded. In some other examples, all of the legs may default to inclusion in a trade order.

The process 900 then determines whether the trading spread includes an additional leg (block 950). If the trading spread includes an additional leg, control returns to block 920 to identify the leg. If the trading spread does not include another leg, the trade order is placed (block 960). The example process 900 then ends.

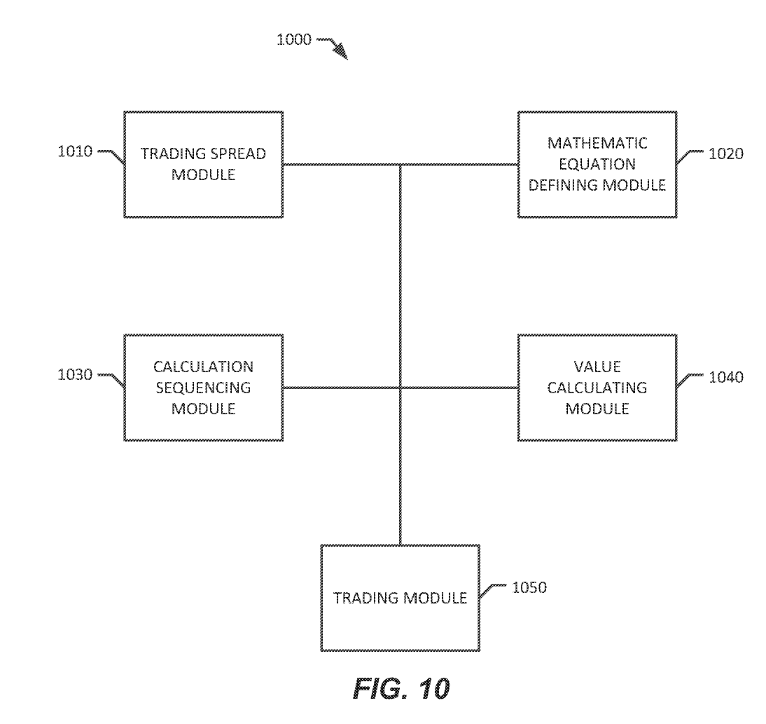

FIG. 10 is a block diagram of an example spread price calculation system 1000 that may implement and/or execute the example operations of FIGS. 5-9. In some examples, the spread price calculation system 1000 may be implemented as a part of a trading application (e.g., the trading application 330 of FIG. 3) associated with the trading device 110 of FIG. 1 and/or the trading device 210 of FIG. 2. In some examples, the spread price calculation system 1000 may be implemented as computer implemented code or instructions operable independent of a trading application. In some examples, the features and functionality of the spread price calculation system 1000 may be implemented in hardware operable in connection with the trading device 110 of FIG. 1 and/or the trading device 210 of FIG. 2.

The example spread price calculation system 1000 of FIG. 10 includes a trading spread module 1010 to define the trading spread used to calculate the spread price. For example, the trading spread module 1010 receives one or more factors associated with defining a leg in the trading spread. For example, the trading spread module 1010 receives what kind of value (e.g., a dynamic value, such as a tradeable object, or a static value, such as a constant) defines the leg. Additionally, a multiplier or spread ratio may be associated with the leg and the example trading spread module 1010 receives this information. In some examples, the trading spread module 1010 receives an indication of whether or not to include the leg in a trade order. In some examples, the trading spread module 1010 receives a price or quantity associated with the leg.

The defined legs are utilized by the example mathematic equation defining module 1020. The example mathematic equation defining module 1020 receives parameters used to define (or describe) a relationship between the legs of the trading spread. For example, the product of two legs may be used to calculate the spread price. The relationship between the legs may include addition, subtraction, multiplication, division and/or any other mathematical operation relating the legs to the spread price. A calculation sequence based on the mathematic equation received from the mathematic equation defining module 1020 is determined by the example calculation sequencing module 1030. For example, a trading spread may include a first leg having a first currency and a second leg having a second currency. Thus, to calculate a meaningful spread price (rather than a nonsensical spread price), the units of at least one of the legs is to be converted to another currency. The example calculation sequencing module 1030 determines that the conversion calculation is made prior to relating the two legs.

The example value calculating module 1040 calculates a spread price of a trading spread based on the mathematic equation. The value calculating module 1040 determines the value of each leg of the trading spread in the mathematic equation. The spread price of the trading spread is then calculated by the value calculating module 1040 according to the sequence determined by the calculation sequencing module 1030.

When a request to trade a trade order is received by the trading module 1050, the trading module 1050 determines which legs of the trading spread to include in the trade order. For example, a leg may be defined by a value that cannot be traded (e.g., a constant value). Thus, the trading module 1050 excludes that leg from a trade order that includes the trading spread. In some examples, only a portion of the legs may be selected to include in a trade order. For example, a leg may include a tradeable object that can be traded, but the trader selected not to include the leg in the trade order. As a result, the trading module 1050 adds only the legs selected to include in the trade order. In some examples, the trading module 1050 adds a leg with a quantity of zero when the leg is not selected to include in the trade order.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

1. A method to calculate a spread price comprising:
receiving, via an electronic trading device, a trading spread including a plurality of legs, wherein each leg of the plurality of legs is associated with a tradeable object;
facilitating, via the electronic trading device, a definition of a mathematic equation to describe a relationship between each of the plurality of legs based on at least two parameters relating the plurality of legs to the spread price, where at least one parameter of the at least two parameters is variable according to changes in a market for at least one of the plurality of legs; and
calculating, via the electronic trading device, the spread price based on the defined mathematic equation.

2. A method as described in claim 1 further comprising determining, via the electronic trading device, a calculation sequence based on the mathematic equation and the at least two parameters.

3. A method as described in claim 1 wherein one of the at least two parameters in the mathematic equation is a variable that is to relate one of the plurality of legs to another of the plurality of legs.

4. A method as described in claim 1 wherein one of the at least two parameters in the mathematic equation is a constant that is to relate one of the plurality of legs to another of the plurality of legs.

5. A method as described in claim 1 wherein one of the at least two parameters is to include at least one of addition, subtraction, multiplication, division or delimiter of at least one of the plurality of legs.

6. A method as described in claim 1 further comprising calculating, via the electronic trading device, a plurality of leg values that is to correspond to the plurality of legs.

7. A method as described in claim 6 wherein the spread price is to include the plurality of leg values.

8. A method as described in claim 1 further comprising:
facilitating, via the electronic trading device, placement of a trade order to an exchange based on the trading spread, wherein the trade order is to include a leg quantity corresponding to each leg of the plurality of legs.

9. A method as described in claim 8 wherein the trade order is to include less than all of the plurality of legs.

10. A method as described in claim 8 wherein at least one of the leg quantities is zero.

11. A method to define a trading spread having a plurality of tradeable objects comprising:
facilitating, via an electronic trading device, a definition of a first leg used in the trading spread, wherein the first leg is a tradeable object;
facilitating, via the electronic trading device, a definition of a second leg used in the trading spread, wherein the second leg is a tradeable object; and
facilitating, via the electronic trading device, a definition of the trading spread to include the first leg and the second leg, wherein the trading spread is based on a mathematic equation that describes a relationship between the first leg and the second leg, and the relationship is based on at least a parameter related to at least the first leg or the second leg, and wherein the parameter is variable according to changes in a market for at least one of the first leg and the second leg.

12. A method as described in claim 11 wherein the first leg is to include a leg multiplier and a leg value.

13. A method as described in claim 11 wherein the parameter is selected from a plurality of parameters.

14. A method as described in claim 11 further comprising calculating, via the electronic trading device, a spread price based on the trading spread.

15. A method as described in claim 14 further comprising facilitating, via the electronic trading device, placement of a trade order to an exchange based on the spread price.

16. A method as described in claim 15 wherein the trading spread is to include at least a third leg and at least a second parameter.

17. A method as described in claim 16 wherein the trade order is to include less than all of the first leg, the second leg and the third leg.

18. A method as described in claim 16 wherein the relationship between the first leg and the second leg is to change based on the second parameter.

19. A method as described in claim 15 wherein the trade order is to include a leg quantity that is to correspond to each of the respective legs.

20. A method as described in claim 19 wherein at least one of the leg quantities is zero.

21. A non-transitory tangible computer readable storage medium including computer program code to be executed by a processor, which when executed is configured to implement a method to calculate a spread price, the method comprising:
receiving a trading spread including a plurality of legs, wherein each leg of the plurality of legs is associated with a tradeable object;
facilitating a definition of a mathematic equation that describes a relationship between each of the plurality of legs based on at least two parameters relating the plurality of legs to the spread price, where at least one parameter of the at least two parameters is variable according to changes in a market for at least one of the plurality of legs; and
calculating a leg value corresponding to each of the plurality of legs; and
calculating the spread price based on the mathematic equation.

22. A non-transitory tangible computer readable storage medium as described in claim 21 wherein the parameter is selected from a plurality of parameters.

23. A non-transitory tangible computer readable storage medium as described in claim 21 further comprising facilitating placement of a trade order to an exchange based on the spread price, wherein the spread price is to include a third leg price corresponding to a third leg.

24. A non-transitory tangible computer readable storage medium as described in claim 23 wherein the trade order is to include a leg quantity corresponding to each of the respective legs.

25. A non-transitory tangible computer readable storage medium as described in claim 24 wherein at least one of the leg quantities is zero.

26. A non-transitory tangible computer readable storage medium as described in claim 23 wherein the trade order is to include less than all of the legs.
